(19) United States
(12) Patent Application Publication
(10) Pub. No.: US 2016/0378704 A1
(43) Pub. Date: Dec. 29, 2016

(54) DYNAMICALLY CONFIGURE CONNECTION MODES ON A SYSTEM BASED ON HOST DEVICE CAPABILITIES

(71) Applicant: Intel Corporation, Santa Clara, CA (US)

(72) Inventors: Peter S. Adamson, Portland, OR (US); James R. Trethewey, Hillsboro, OR (US); Kandasubramaniam K. Palanisamy, Hillsboro, OR (US)

(73) Assignee: Intel Corporation, Santa Clara, CA (US)

(21) Appl. No.: 14/752,501

(22) Filed: Jun. 26, 2015

(51) Int. Cl. G06F 13/364; G06F 13/40; G06F 13/38; G06F 13/42

(52) U.S. Cl. CPC G06F 13/364; G06F 13/4282; G06F 13/4081; G06F 13/385

(57) ABSTRACT

An apparatus for configuring connection modes is described herein. The apparatus includes a plurality of ports and a processor. A first port is to couple a first device to the apparatus, the first port configurable to communicate via one mode of a plurality of modes. The processor is to include a policy manager, wherein the policy manager is to negotiate the one mode at the first port based on a mode of a second port of the plurality of ports.

### TECHNICAL FIELD

The present techniques relate generally to the selection of a connection type over a shared connection when an endpoint device supports multiple connection types. More specifically, the present techniques relate to a methodology for dynamically configuring USB Type-C usage amongst Type-C ports on a device or docking station.

### BACKGROUND ART

When a device is attached to a port of a host system, it can redistribute data signals received from the upstream port attached to the host system to any of one or more downstream ports of the device. Similarly, the downstream ports may share a connection to the upstream port and send data to the host system via the upstream port. The order in which the downstream ports access the shared upstream port may determine the connection quality for the downstream ports, as a first downstream port may control pins and data lines needed by a second downstream port.

### BRIEF DESCRIPTION OF THE DRAWINGS

FIG. 1 is a block diagram of a system on chip (SoC) on a printed circuit board (PCB);

FIG. 2 is an illustration of a system with multiple ports;

FIG. 3 is an illustration of a DisplayPort dongle and a USB dongle;

FIG. 4 is a process flow diagram of a method for negotiation when a DisplayPort dongle is connected to a dock walk-up port;

FIG. 5 is a process flow diagram of a method for negotiation when a USB device is connected to a dock walkup port;

FIG. 6 is a process flow diagram of a method for saving negotiated alternate modes;

FIG. 7A is a process flow diagram of a method for a slave port chip edge policy manager;

FIG. 7B is a process flow diagram a method for a master port chip edge policy manager;

FIG. 8A is a block diagram showing tangible, non-transitory computer-readable media that stores code for a centralized policy manager;

FIG. 8B is a block diagram showing tangible, non-transitory computer-readable media that stores code for an edge policy manager; and

FIG. 9 is a block diagram of components present in a computer system in accordance with an embodiment of the present invention.

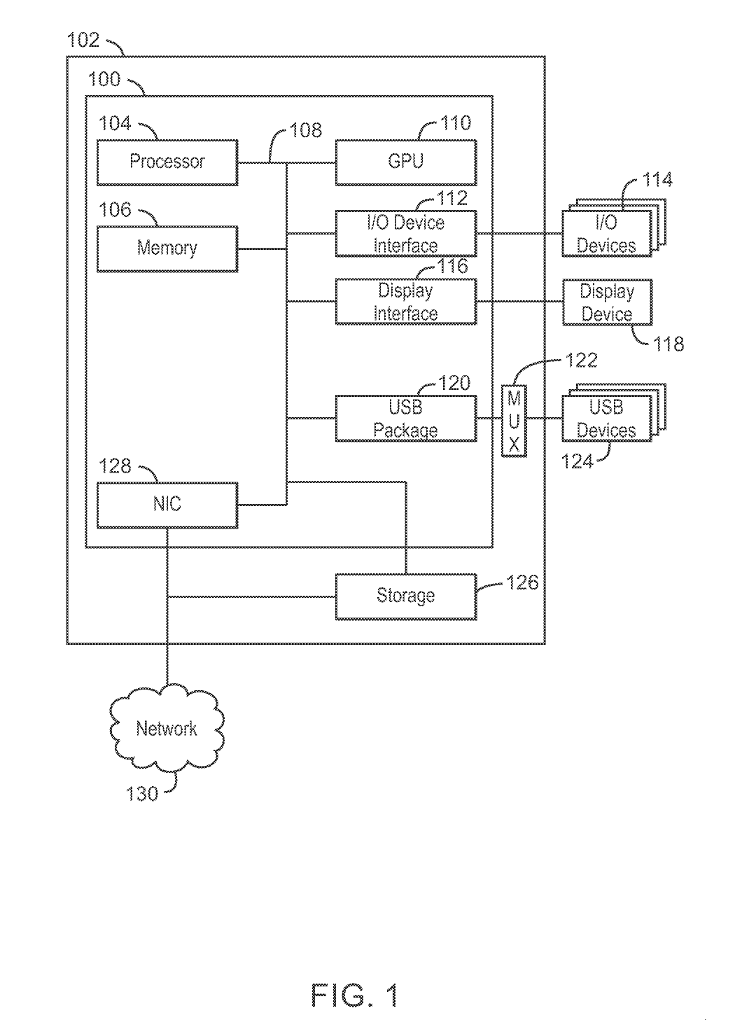

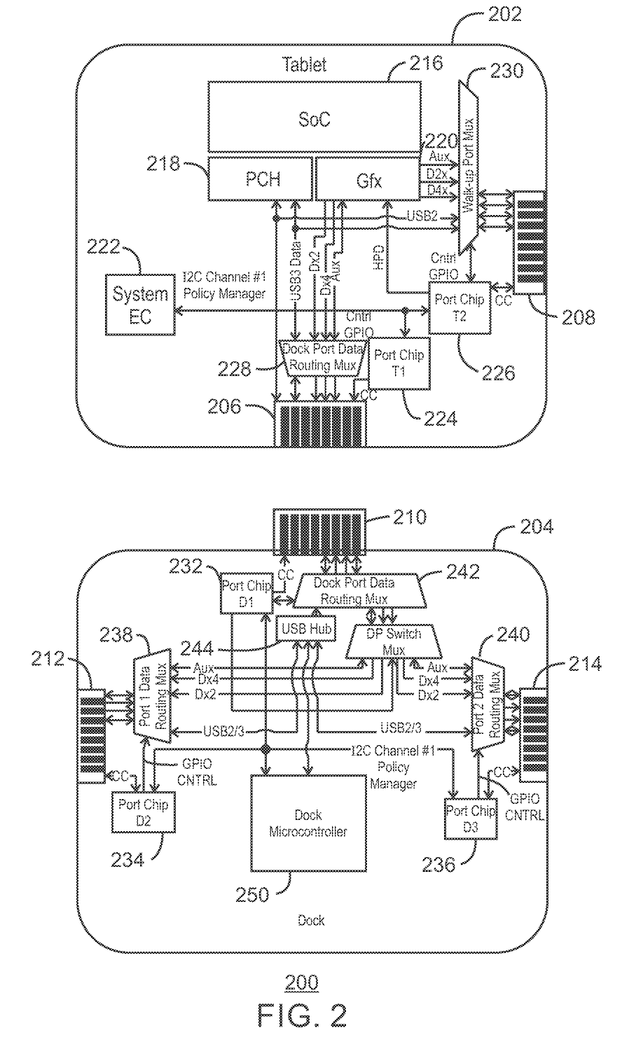

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The connection quality for multiple ports using a shared connection can be changed based on several factors. In examples, the shared connection is a port that is coupled with a host system. The host system may be a computing device, such as a tablet, and the tablet is to be coupled with a dock that includes multiple ports. The shared connection and multiple ports can adhere to a variety of Specifications, such as any Specifications by the Universal Serial Bus Implementers Forum (USB-IF). The shared connection can also be implemented according to Peripheral Component Interconnect Express (PCIe) Specification, such as the PCI Express 3.0 Specification released in November 2010. The shared connection can be implemented according to any Display Port Specification of the Video Electronics Standard Association (VESA) such as the VESA DisplayPort Standard 1.3 released in September 2014. The present techniques are described according to the USB Type-C Cable and Connector Specification Revision 1.0, Aug. 11, 2014 as an example and for ease of description. However, any connection capable of supporting multiple protocols and Specifications can be used.

USB Type-C enables several connection types, such as USB2, USB3, PCIe, HDMI, DisplayPort, and so on, to be operable over one physical connection. The same pins can be used to enable multiple connection types. The USB2 is according to the Universal Serial Bus 2.0 Specification released April 2000. The USB3 is according to the Universal Serial Bus 3.1 Specification released on July, 2013. A High-Definition Multimedia Interface (HDMI) connection may be according to the HDMI Specification Ver. 2.0 released September 2013. The various connection types may be realized through alternate modes, as enabled by the USB Type-C Specification. In particular, the USB Type-C Specification enables signal pins to be reassigned for purposes other than a USB2/USB3 data transmission. These reassignments are referred to as alternate modes. Each USB Type-C Port can support zero or more alternate modes. While the present techniques are described using alternate modes as enabled by the USB Type-C Specification, any mode may be used. Accordingly, the alternate modes described herein are for exemplary purposes.

The alternate modes are subject to the particular resources of the system, as well as pin configurations designated by the USB Type-C Specification. When a single Type-C connector that supports alternate modes is connected to host system, but itself can serve as the pathway to the host system for multiple downstream Type-C connections that also support alternate modes, a race situation to access system resources can occur between the various devices connected to the system.

Embodiments described herein are related to a methodology for dynamically configuring usage of shared connections amongst the ports of a device or docking station. In particular, the present techniques can be applied to USB Type-C usage amongst Type-C ports of a device or docking station.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus′, methods, and systems described herein are not limited to physical computing devices, but may also relate to software optimizations for energy conservation and efficiency. As will become readily apparent in the description below, the embodiments of methods, apparatus′, and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

FIG. 1 is a block diagram of a system on chip (SoC) 100 on a printed circuit board (PCB) 102. The SoC 100 and PCB 102 may be components of, for example, a laptop computer, desktop computer, Ultrabook, tablet computer, mobile device, or server, among others. The SoC 100 may include a central processing unit (CPU) 104 that is configured to execute stored instructions, as well as a memory device 106 that stores instructions that are executable by the CPU 104. The CPU may be coupled to the memory device 106 by a bus 108. Additionally, the CPU 104 can be a single core processor, a multi-core processor, a computing cluster, or any number of other configurations. Furthermore, the SoC 100 may include more than one CPU 104.

The SoC 100 may also include a graphics processing unit (GPU) 110. As shown, the CPU 104 may be coupled through the bus 108 to the GPU 110. The GPU 110 may be configured to perform any number of graphics functions and actions. For example, the GPU 110 may be configured to render or manipulate graphics images, graphics frames, videos, or the like, to be displayed to a user of the SoC 100. The memory device 106 can include random access memory (RAM), read only memory (ROM), flash memory, or any other suitable memory systems. For example, the memory device 106 may include dynamic random access memory (DRAM).

The CPU 104 may be connected through the bus 108 to an input/output (I/O) device interface 112 configured to connect the SoC 100 through various layers of the PCB 102, and components of the PCB 102 to one or more I/O devices 114. The I/O devices 114 may include, for example, a keyboard and a pointing device, wherein the pointing device may include a touchpad or a touchscreen, among others. The I/O devices 114 may be built-in components of a platform including the SoC 100, or may be devices that are externally connected to a platform including the SoC 100. In embodiments, the I/O devices 114 may be a keyboard or a pointing device that is coupled with a USB package 120 of the SoC 100 by means of MUX 122.

The CPU 104 may also be linked through the bus 108 to a display interface 116 configured to connect the SoC 100 through various layers of the PCB 102, and components of the PCB 102 to one or more display devices 118. The display device(s) 118 may include a display screen that is a built-in component of a platform including the SoC 100. Examples of such a computing device include mobile computing devices, such as cell phones, tablets, 2-in-1 computers, notebook computers or the like. The display device 118 may also include a computer monitor, television, or projector, among others, that is externally connected to the SoC 100. In embodiments, the display devices 118 may be a DisplayPort device that is coupled with a USB package 120 of the SoC 100 by means of a multiplexer (MUX) 122.

The USB package 120 may include a transmitter and a receiver in order to transmit and receive USB data. The USB package 120 may also include components necessary to implement the USB Battery Charging Specification, USB On-the-Go Specification, and the USB Power Delivery Specification, and the USB Type-C Specification. The PCB 102 may also include components to implement the various USB Specifications. Data from the USB package 120 may be sent to the MUX 122 and on to a plurality of USB devices 124. In embodiments, the USB devices 124 are devices that support multiple protocols or USB Type-C devices. The MUX 122 may be used to select between various USB features enabled by the USB package 120. For example, the MUX 122 may be used to implement USB 2.0, USB 3.0, USB Battery Charging, USB Power Delivery, HDMI, DisplayPort, or PCIe, among others.

In embodiments, the plurality of USB devices 124 may compete for use and control of resources of the SoC 100. Depending on the particular USB devices coupled with the SoC 100, some devices may be over provisioned. In other words, a device may have control of resources that are not being used by the device. A policy manager is to dynamically assign resources to each device on a shared connection. In embodiments, a user can select a connection type for one or more devices. The policy manager can determine which connection types can co-exist on a shared connector.

The SoC 100 may also be coupled with a storage device 126. The storage device may be a component located on the PCB 102. Additionally, the storage device 126 can be a physical memory such as a hard drive, an optical drive, a thumb drive, an array of drives, or any combinations thereof. The storage device 126 may also include remote storage drives. The SoC 100 may also include a network interface controller (NIC) 128 may be configured to connect the SoC 100 through the bus 108, various layers of the PCB 102, and components of the PCB 102 to a network 130. The network 130 may be a wide area network (WAN), local area network (LAN), or the Internet, among others.

It is to be understood that the block diagram of FIG. 1 is not intended to indicate that the SoC 100 is to include all of the components shown in FIG. 1. Rather, the SoC 100 can include fewer or additional components not illustrated in FIG. 1. Furthermore, the components may be coupled to one another according to any suitable system architecture, including the system architecture shown in FIG. 1 or any other suitable system architecture that uses a data bus to facilitate communications between components. For example, embodiments of the present techniques can also be implemented any suitable electronic device, including ultra-compact form factor devices, such as SoC and multi-chip modules. The present techniques may also be used on any electrical cable inside or outside of a computer that is used to carry digital information from one point to another. For example, embodiments of the present techniques may be used for connecting disk drives.

When a single connector that supports alternate modes is connected to host system but itself is a connection shared by multiple downstream ports to access the host system, a methodology is used for sharing and arbitrating the limited resources of the single host connection. In this manner, any race situation to access system resources is avoided. In embodiments, a user can designate the capabilities of each device to customize operation of the devices for each user.

FIG. 2 is an illustration of a system 200 with multiple ports. The system 200 includes a tablet 202 and a dock 204. In embodiments, the system 200 includes USB ports. For example, the tablet 202 includes a female port 206 and a female port 208. The female port 206 and the female port 208 may each be USB Type-C ports. The USB Type-C Specification 1.0, released August 2014, describes a connector for the transmission of USB signals. The USB Type-C connector uses active electronics for configuration management, such as orientation and role detection and sideband message passing. Active electronics include but are not limited to a port chip and a port data routing multiplexer (mux).

In addition to or alternatively, the port 206 of the tablet 202 may be a Type-C docking receptacle and the port 208 may be a Type-C walkup receptacle. In embodiments, a docking receptacle or port is used for docking purposes with another device, which includes coupling a plurality of devices together. Additionally, in embodiments, a walk-up receptacle or port is a receptacle or port that can receive a connector that is in turn connected with any sort of device, such as a thumb drive, media player, or a display. The dock 204 includes a male port 210, a female port 212, and a female port 214. The male port may be a USB Type-C docking plug. The USB Type-C docking plug of the dock can couple with a Type-C docking receptacle 206 of the tablet 202. The female port 212 and the female port 214 may each be a Type-C walkup receptacle. Although particular docking and walk-up receptacles are described, a tablet may include any number of walk-up receptacles and docking receptacles. Similarly, the dock 204 may include any number of docking plugs and walk-up receptacles.

For example, a docking receptacle or port is used for docking purposes with another device, which includes coupling a plurality of devices together. The docking port can be used to “dock” a first device with a second device. In an example, the first device is a dock, and the second device is a tablet or laptop. By docking the two devices via a docking port, the functionality of the table or laptop can be expanded, such that the tablet or laptop functions as a larger computing device. In examples, a larger computing device is a desktop computer, server, and the like. A walk-up port can receive a connector that is in turn connected with any sort of device, such as a thumb drive, media player, or a display. The walk-up port enables a user to connect various peripheral devices with the either the first device or the second device.

The tablet 202 also includes a System on Chip (SoC) 216. The SoC 216 can be the SoC 100 (FIG. 1). Further, the tablet 202 includes a platform controller hub (PCH) 218. The PCH 218 is to control various data paths and support functions of the SoC 216. A graphics engine (Gfx) or graphics processing unit (GPU) 220 may be configured to render or manipulate graphics images, graphics frames, videos, or the like. In embodiments, the Gfx 220 may be a portion of the SoC, as described with respect to FIG. 1. The tablet 202 also includes a system embedded controller (EC) 222. The system EC 222 is to communicate various policies and system configurations with a port chip T1 224 and a port chip T2 226. The port chip T1 224 is adjacent to the docking receptacle 206, and port chip T2 226 adjacent to the walk-up receptacle 208. A docking port data routing multiplexer (mux) 228 is to route data from the dock 204 amongst various components of the tablet 202. Similarly, a walk-up port mux 230 is to route date from the port 208.

The dock 204 includes a dock microcontroller 250 that is to communicate various policies and configurations with a port chip D1 232, a port chip D2 234, and a port chip D3 236 when implementing centralized policy management. When edge policy management is used, policy management functionality may be located at each port chip, eliminating or reducing the need for a microcontroller that performs centralized policy management. A port1 data routing mux 238 is used to route data from the port 212. Similarly, a port2 data routing mux 240 is used to route data from the port 214. A dock port data routing mux 242 is to route data from the dock plug 210. Additionally, a USB hub 244 is to route USB2.0 and USB3 data to and from the ports. A DisplayPort (DP) switch MUX 246 is used to route DP data to and from the ports.

In embodiments, the docking plug 210 is to connect with the either of the ports 206 or 208 of the tablet 202. In the example of system 200, the port 206 is illustrated as receiving the docking plug 210. A user can further connect the tablet 202 or the dock 204 to specific endpoints like USB devices, audio headsets, or DisplayPort displays by plugging a connector into any of the female ports of the tablet 202 or the dock 204. When the female ports are Type-C female ports, two USB devices can be supported simultaneously at a single port via a USB Hub. However, only a single DisplayPort device can be supported by a Type-C port. This is due to pin configurations specified by the USB Type-C Specification and the USB Power Delivery (USB-PD) Specification 2.0, released August 2014 and corresponding Adopters Agreement and ECNs approved through Nov. 26, 2014. Sample usages in a USB Type-C embodiment are discussed below with respect to Table 1.

In particular, the USB-PD Specification 2.0 describes the methods and contents of the side-band management message passing. One class of these messages is for the purpose of USB-PD. Through these messages, a port entity (device) at either end of a Type-C cable can negotiate a device status and choose to provide (“source”) or consume (“sink”) power. Accordingly, the power contract between the two port entities can be negotiated via message passing. A second class of messages is for the purpose of dynamic redefinition of a subset (any combination of up to twelve) of the twenty-four pins of a Type-C connector, and are called alternate modes. Both industry-standard alternate modes and vendor-proprietary alternate modes can be defined by a system designer.

In some embodiments, the Type-C configuration management, USB-PD control, and alternate mode control is performed by means of a port controller chip positioned immediately adjacent to each mechanical connector, such as a plug, receptacle, or port. The port controller chips, such port chip T1 224, port chip T2 226, port chip D1 232, port chip D2 234, and port chip D3 236 are typically either a general-purpose microcontroller supported by specialized discrete companion electronics, or are special purpose microcontrollers incorporating all required functionality in a single chip package. In operation, each port chip is a controller that contains firmware instructions that implement the Specifications' requirements. This firmware is typically stored in a non-volatile memory region of the FLASH type.

Furthermore, alternate modes defined by the USB Specifications are negotiated by an entity called a policy manager. The policy manager can execute on any port chip or another CPU that can communicate with the port chip. Other CPU's include the dock microcontroller 250 or the system embedded controller 222. In embodiments, when there is more than one port chip on a tablet 202 or more than one port chip on the dock 204, a single separate microcontroller such as the dock microcontroller 250 or the system embedded controller 222 can serve as the policy manager. Centralized policy management refers to a scenario when a separate microcontroller serves as the policy manager. Edge policy management refers to a scenario where each port chip participates in policy management.

Policy management is used to determine the modes that are implemented concurrently across port and receptacle combinations within a system. Alternate modes can be used to repurpose many of the twenty-four pins on a Type-C connector, many common modes such as USB2, USB3 & DisplayPort 4k, PCI-E and anything other than USB2, HD Audio & DisplayPort 4k, etc. do not co-exist over the same connection as the same pins are needed for each union of modes. For example, DisplayPort, operating across a Type-C connector (Assignment E, 4 lanes) can drive full monitor resolutions at least 4K and is referred to as DisplayPort 4k. Such an implementation of DisplayPort uses four data lanes of the Type-C connector (Dx4), and conflicts with the same pins used by USB3. The Dx4 mode also uses the secondary bus (SBU) pins, which conflict with Analog Audio. In embodiments, analog audio is implemented by multiplexing four analog audio signals onto pins of the USB Type-C connector when in the Audio Adapter Accessory Mode. However, DisplayPort can also operate (Assignment F, 2 lanes) and is referred to as DisplayPort High Definition (HD). This implementation of DisplayPort uses two data lanes (Dx2) of the Type-C connector and results in a lower display resolution when compared to DisplayPort 4k. DisplayPort at Dx2 only conflicts with Analog Audio, and not with USB3. Accordingly, Display port at Dx2 can operate across the same Type-C connector concurrently with USB3. Similarly, PCI-Express (2 Lanes) conflicts with both USB3 and Analog Audio (and DisplayPort 4 lanes), but PCI-Express (1 lane) only conflicts with Analog Audio (and DisplayPort 2 lanes). While not all alternate mode combinations result in resource conflicts, there are many combinations that do generate conflicts that require a strategy for resolution. Moreover, the alternate mode combinations described herein are for exemplary purposes. Any alternate mode combination (including a near-infinite number of vendor-proprietary alternate modes) can be used according to the present techniques.

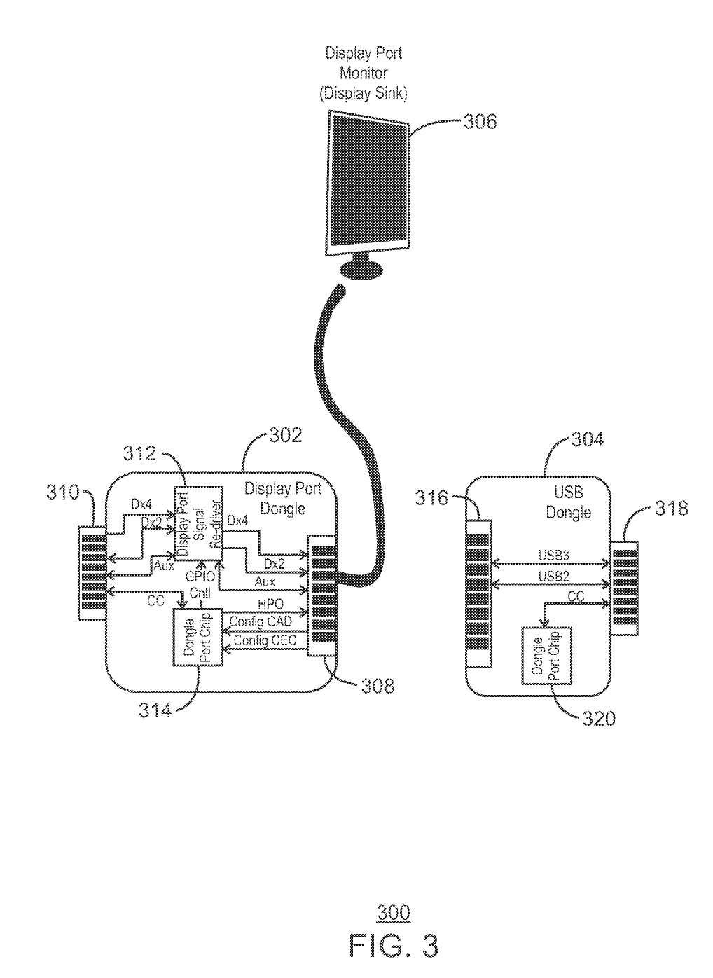

In order for host devices to properly process the alternate modes, not only must the pins on the Type-C connector be repurposed, but the data lines leading from the connector to their sources must also be repurposed. For example, data lines to the peripheral controller hub (PCH) or host processor are also repurposed. In embodiments, the data lines are repurposed on the host processor by using switches to re-route the data or data paths inside the PCH or host processor. The Type-C connectors would reconfigure the Type-C pins for their specific endpoint devices using active Type-C dongles shown in FIG. 3.

FIG. 3 is an illustration of a DisplayPort dongle 302 and a USB dongle 304. The DP monitor 306 is a display sink. As described herein, a dongle is any component containing active electronics that attaches to an external connector of a system, thereby providing some form of signal adaptation, typically presented on a connector with different form-factor than the system has. In examples, the component may be a cable. Examples of dongles include USB Type-A cables that convert to DB9 serial, DB25 parallel printer, RJ45 Ethernet, VGA, etc. In the FIG. 3 examples, the dongle 302 is USB Type-C on one end, and adapts to DisplayPort on the other end. The dongle 318 is USB Type-C on one end, and adapts to USB Type-A on the other end.

Accordingly, in the case of Type-C connectors, the dongles would reconfigure the Type-C pins for their specific endpoint devices. These dongles are called “active” because they incorporate port chips to negotiate with host systems' port chips over the Type-C connection using the communication channel (CC) to advertise their “alternate modes” so that host systems can properly process data from their endpoint devices (or reject the connection if they cannot). For example, a host system may be a tablet 202 (FIG. 2). In this implementation, there would be no alternate mode negotiation for the dock 204 walk-up ports 212 and 214 if the tablet was not docked, but the devices connected to the dock 204 via ports 212 and 214 could be powered. This implementation supports both DisplayPort 4k (DP-4k) and USB3 on the dock over the shared Type-C Dock Port 210. Table 1 lists exemplary connections that can be supported simultaneously via a Type-C connector:

TABLE 1

| Video | USB | Audio |
|---|---|---|
| DP-4K | USB2 only | None |
| DP-HD | USB2 & USB3 | None |
| None | USB2 & USB3 | Digital or Analog |

For example, according to Table 1, when DisplayPort HD is supported, either USB2 or USB3 can be supported, and no audio is supported. With no video, either USB2 or USB3 can be supported, and digital or analog audio is supported.

While the port chips participate in port management, the port chips do not have any connection with the Type-C data channels. Appropriately, the port chips send or receive power and communicate with the other port chips via CC pins. In the case of the DP dongle 302, the port chip 314 does not know whether the connected display 306 is 4K (which uses 4 lanes) or HD (which uses 2 lanes). For the USB3 dongle 304, the port chip 320 is unaware of whether the connected USB device use USB3 or USB2. The dongle can determine the quality or type of the connection required by the endpoint device (ED) via centralized policy management or edge policy management. In embodiments, a policy engine is used to determine the particular connections of each dongle. In this manner, routing data lines such as auxiliary pins for DP or high speed USB3 pins through the port chip is avoided. Without policy management, these data lines would be used by the port chip to determine the connection type. Moreover, routing additional data lines through the port chips uses additional chips to accommodate the high speed signals and uses additional firmware to interpret the protocol to process a handshake with the host system. In some cases, re-routing data lines through the port chips results in degraded signal integrity of the data communication between the host and the endpoint device.

Traditionally, the policy engine would automatically reserve the highest quality mode for each connection type. If the endpoint device does not need this high quality connection, such as DisplayPort 4k or USB3, the endpoint will have unnecessarily oversubscribed resources that the endpoint does not need and does not use. In other words, the endpoint would be overprovisioned. The present techniques rely on enumeration via policy management and discovery application programming interfaces (APIs) built into the host operating system or SoC firmware to determine how to provision resources for the endpoint. Extending messaging is also used to augment standardized specification protocols, such as the protocols specified in the USB Specifications.

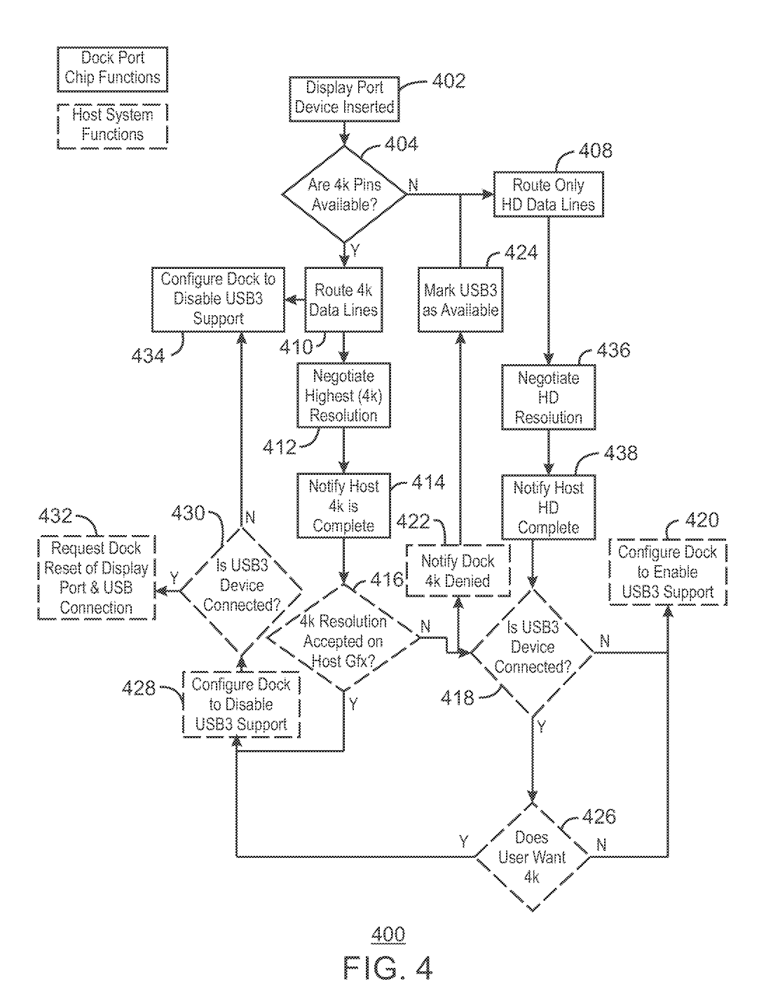

FIG. 4 is a process flow diagram of a method 400 for negotiation when a DisplayPort dongle is first connected to a dock walk-up port. Dock port chip functions are illustrated with solid lines, while host system functions are illustrated with dashed lines. Although functions are illustrated as dock port chip functions or host system functions, any component of the system may perform each function. At block 402, the DisplayPort device is inserted or coupled with a port of a dock. At block 404, it is determined if pins are available to support DisplayPort operation at a resolution of 4K or higher. If pins are not available to support DisplayPort operation at a resolution of 4K or higher, process flow continues to block 408. If pins are available to support DisplayPort operation at a resolution of 4K or higher, process flow continues to block 410.

At block 408, HD data lines are routed and assigned to the current port of the dock. This implementation of DisplayPort uses two data lanes (Dx2) of the Type-C connector and results in a lower display resolution when compared to DisplayPort 4k. After HD data lines are routed and assigned to the current port, the HD resolution is negotiated at block 436. At block 438, the host is notified by the dock that HD resolution negotiation is complete. At block 418, it the host determines if a USB3 device is connected to the dock. If a USB3 device is connected to the dock, process flow continues to block 426. If a USB3 device is not connected to the dock, process flow continues to block 420. At block 420, the dock is configured to enable USB3 support.

At block 426, it is determined if a user wants to enable high resolution DisplayPort at DP-4K. If the user wants to enable DP-4K, process flow continues to block 428. If the user does not want to enable high resolution DisplayPort, process flow continues to block 420, where USB3 support is enabled. At block 428, the host configures the dock to disable USB3 support. At block 430, the host determines if a USB3 device is connected to the dock. If a USB3 device is connected to the dock, process flow continues to block 432. If a USB3 device is not connected to the dock, process flow continues to block 434. At block 432, a dock reset of the DisplayPort and USB connection is performed. At block 434, the dock is configured to disable USB3 support.

When process flow continues to block 410 from block 404, DP-4k lines are routed. The highest resolution (DP-4k) is negotiated at block 412. At block 414, the host is notified that the highest resolution negotiation is complete. At block 416, it is determined if the high resolution is accepted on the host graphics processor. If the high resolution is accepted on the host graphics processor, process flow continues to block 428, where the host system is to configure the dock to disable USB3 support as described above. If the high resolution is not accepted on the host graphics processor, process flow continues to block 418, where the host system is to determine if a USB3 device is connected to the host system as described above.

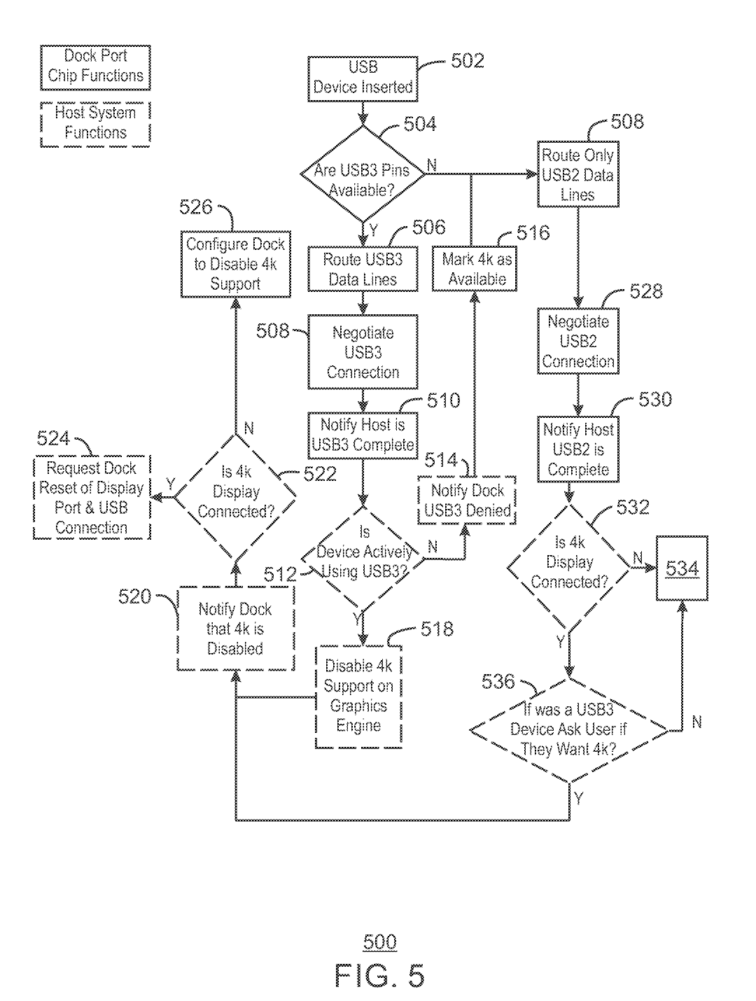

FIG. 5 is a process flow diagram of a method 500 for negotiation when a USB device is first connected to a dock walkup port. The method 500 is analogous to the method 400, but applies when a USB dongle is first connected to a dock walkup port. In this case, if USB2 is selected by the host (instead of USB3) and a DP-4k display is connected, the user is notified that a faster USB connection is available if they scale the display resolution down to HD. While functions are illustrated as dock port chip functions or host system functions, any component of the system may perform each function.

At block 502, the USB device is inserted or coupled with a port of a dock. At block 504, it is determined if pins are available to support USB3 operation. If pins are not available to support USB3, process flow continues to block 508. If pins are available to support USB3, process flow continues to block 506.

At block 508, USB2 data lines are routed and assigned to the current dock port. After USB2 data lines are routed and assigned to the current port, the USB2 resolution is negotiated at block 528. At block 530, the host is notified that USB2 connection negotiation is complete. At block 532, the host system determines if a 4k or higher resolution display is connected at the host. If a 4k or higher resolution display is not connected to the host system, process flow continues to block 534. If a 4k or higher resolution display is connected to the host system, process flow continues to block 536. At block 534, no change occurs as no display is connected where a policy decision should be applied.

At block 536, it is determined if a user wants to enable high resolution DisplayPort connection at DP-4K. If the user wants to enable high resolution DisplayPort, process flow continues to block 520. If the user does not want to enable high resolution DisplayPort, process flow continues to block 534. At block 520, the dock is notified that 4K is disabled. At block 522, it is determined if a 4k display is connected to the host system. If a 4k display is connected to the host system, process flow continues to block 524. If a 4k display is not connected to the host system, process flow continues to block 526. At block 524, the host system requests a reset of the Display Port and USB connection. At block 526, the dock is configured to disable DisplayPort 4k support.

When process flow continues to block 506 from block 504, the USB3 data lines are routed. At block 508, the USB3 connection is negotiated by the dock. At block 510, the dock notifies the host that USB3 negotiation is complete. At block 512, it is determined if the connected USB device is actively using USB3. If it is determined if the connected USB device is actively using USB3, process flow continues to block 518 where 4k support is disabled on the graphics engine as discussed above. If it is determined if the connected USB device is not actively using USB3, process flow continues to block 514 where the dock is notified that USB3 is denied. Process flow continues to block 516, where the dock designates DisplayPort 4k resolution as available.

As illustrated by FIGS. 4 and 5, the policy manager will negotiate for the highest connection combination possible whenever a Type-C device is plugged in. If a DisplayPort dongle is plugged in first, the highest quality connection would be DP-4k and USB2. This is the highest quality connection available for DisplayPort coupled with the highest quality USB connection available when DP-4k (the highest quality connection available for DisplayPort) is implemented. If a USB3 dongle is plugged in first as illustrated by FIG. 5, then the highest quality connection combination would be USB3 and DP-HD. Once the dongle is plugged in standard USB-IF protocols are used to power up the dongle, orientation is determined (the plugs are reversible), and then alternate mode (AM) negotiation begins. In FIG. 4, first the current state of the dock port is checked to see if DP-4k is available. If it is, then DP-4k data routing is performed and then DP-4k alternate mode is selected (and USB3 is implicitly disabled). If not, DP-HD routing is performed and DP-HD is selected.

The host system then receives a notification from the dock using a custom Human Interface Device (HID) message that an alternate mode selection has been made. The host system then waits for the DP connection with the endpoint to appear. In examples, HID refers to the Human Interface Device set of standards, also promulgated by the USB-IF. The HID standards define a messaging protocol traditionally used by devices such as keyboards, mice, joysticks, and touch-screens. However, the HID standards are flexible enough to be used for many other functions, including vendor-proprietary message extensions. In embodiments, vendor-proprietary HID messages can be used to communicate advisory information between the dock and the tablet. HID messaging is “USB native” and can be exchanged over the USB2 pins which (according to the Type C Specification) are guaranteed to be available for USB2 communication in all Alternate Modes with only 2 exceptions: the Analog Accessory and Debug Accessory modes. In embodiments, the Advisory Information messages can be exchanged over the CC pins themselves using unstructured or structured vendor defined messaging (VDM).

After the host system receives the message that an alternate mode selection has been made and an endpoint appears, the type of connection is determined. If the connection is DP-4k, the host sends a message to disable USB3 (via the same HID channel) which confirms the connection. If the connection is HD then the host sends a message for the dock that the DP-HD was accepted (4k was rejected) to perform HD data routing and enable USB3. If a USB3 device was previously connected before the DP-HD display is connected and the display was 4k capable (information obtained from the host negotiation) then the USB3 connection forced the selection of HD. At this time, the user is informed that they can have a higher resolution display in exchange for “backing down” from their high speed USB3 connection to USB2 on their USB device. If the user desires higher DisplayPort resolution, they are warned to check that the USB3 device can be reset, and then DP-4k combined with USB2 is selected as default and then the Type-C ports are reset and the connections are renegotiated.

FIGS. 4 and 5 describe an exemplary conflict resolution according to USB3 and DisplayPort 4K. However, the same negotiation can occur between any I/O standards that compete for the resources of a system. Furthermore, note that even if Type-C dongles were not used, and the dock had a fixed, dedicated DisplayPort and USB connectors, the same conflict negotiation as described in FIGS. 4 and 5 would be necessary to take advantage of 4k DisplayPort and/or USB3.

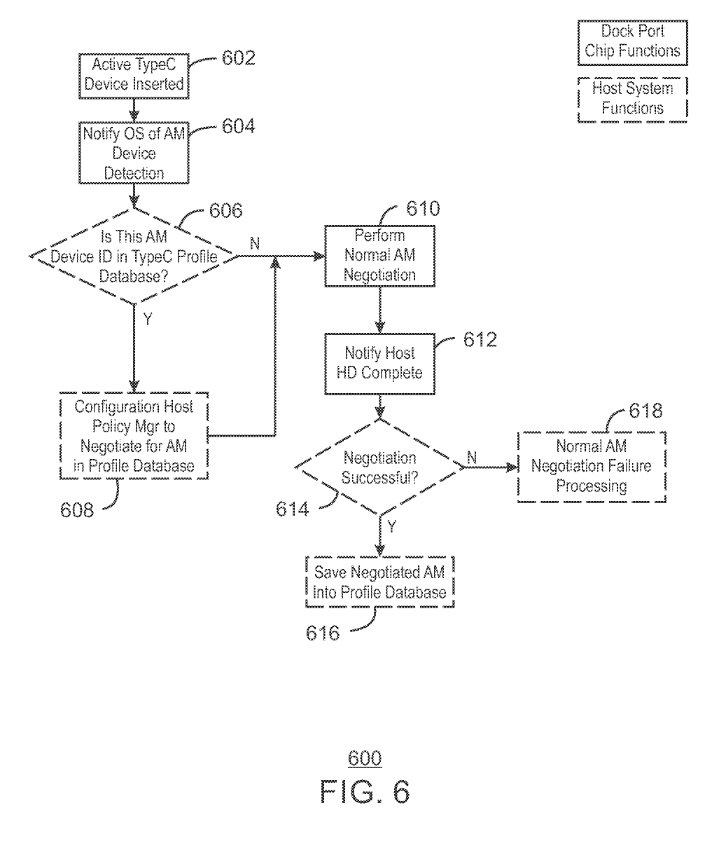

FIG. 6 is a process flow diagram of a method 600 for saving negotiated alternate modes. At block 602 an active Type-C device is inserted. At block 604, the operating system (OS) is notified of the alternate mode device detection. At block 604, it is determined if the alternate mode device ID is in a Type-C profile database. If the alternate mode device ID is in the Type-C profile database, process flow continues to block 608. If the alternate mode device ID is not in the Type-C profile database, process flow continues to block 610.

At block 608, the policy manager is configured to negotiate for the alternate mode found in the profile database. At block 610, normal alternate mode negotiation is performed. This alternate mode negotiation may be as described in FIGS. 4 and 5. At block 612, the host is notified that negotiation is complete. At block 614, it is determined if the alternate mode negotiation was successful. If the alternate mode negotiation was successful, process flow continues to block 616. If the alternate mode negotiation was not successful, process flow continues to block 616. At block 616, the negotiated alternate mode is saved into the Type-C profile database. At block 618, negotiation failure processing is performed.

As illustrated in FIG. 6, the first time an alternate mode capable device is attached, the negotiation occurs as described in FIGS. 4 and 5. Then, the device ID and negotiated alternate mode is then saved upon completion of the negotiation. The device ID and negotiated alternate mode may be saved in a Type-C profile database. The next time the device is connected, the device profile is obtained from the Type-C profile database and that same alternate mode (which was previously negotiated the last time the device connected to that dock) is selected.

In this manner, the host system records the negotiated alternate mode with the identity of the device that the negotiation was with for later use. Consider a keyboard dock at home that can be used certain devices and another dock (with a different ID) at work for use with the same class of devices. A user can have the same experience every time either dock is used. For example, both docks can have DP-4k displays and USB3 devices attached to them. At work, a user may want USB3 and DP HD (1080p), but at home the user prefers DP-4k and USB2. Without saving the negotiated alternate modes, the same alternate mode may be negotiated on both docks each time the host (tablet) is plugged in to the docks. This means the user would need to switch alternate modes whenever the user switched docks. By saving the device ID and alternate mode, host system can save the identity of each dock and how it was used last, resulting in the same dock specific alternate mode every time the dock is used. In this example, 4k/USB2 is used at home and 1080p/USB3 at is used work.

As described above, the present techniques can be implemented using a central policy manager that may execute, for example, on a microcontroller of the dock. In embodiments, a central policy manager is implemented by routing all alternate mode decisions through one central logic center. Such an implementation can result in code running at each port chip, one single shared policy manager code running at any one time, and one decision maker for the policy on all port chips.

However since each dongle port chip has a “lightweight” policy manager, and since all port chips can control their own data routings in some implementations, the policy manager logic could be on each of the port chips and provide the same functionality as a centralized policy manager. This may be referred to as edge policy management (EPM). There are typically no potential data routing conflicts on the host system/tablet because each port has a dedicated DP channel from the graphics processor or a dedicated USB channel to the USB Hub. As a result, each port chip can perform EPM independently as if the port chips are isolated on a dongle, selecting the alternate mode and configuring the data routing of the port. On the host/dock however, the data route to the host is shared, so EPM at the host requires communication between each of the port chips in order to avoid conflicts and race conditions. The same I2C communication channel that is used for central policy management can be used for edge communication between port chips. In embodiments, since the dock port chip (232, FIG. 2) is the port chip used to connect to the host system, the dock port chip is to make the EPM decisions and each walk-up port (212, 214, FIG. 2) would communicate with the dock port chip to decide which alternate mode to support. Thus, in EPM the dock port chip may be considered a master while the remaining walk-up ports of the dock are considered slaves. This upstream/downstream configuration creates the master/slave relationship among the ports where the walk-up ports defer to the dock port as to which alternate mode they can select when a Type-C connection is detected. The I2C bus will use this same master/slave relationship for messaging.

With EPM, each port chip has the same policy manager code executing with minor differences between the various policy manager codes. The differences include the list of supported alternate modes at each port, the default alternate mode for each port, and a register at each port that stores the allocation of the pins at each port. The list of supported alternate modes at each port may also include a list of alternate mode pins needed and multiplexer settings for data routing for each alternate mode. Since each port chip will have different data routings, each alternate mode has a multiplexer setting. In the case of the dock port, both a data multiplexer and a DisplayPort switch multiplexer is controlled. Additionally, the register at each port may be a 16-bit data register that stores what pins are currently allocated, and may be referred to as the Allocated Pin register.

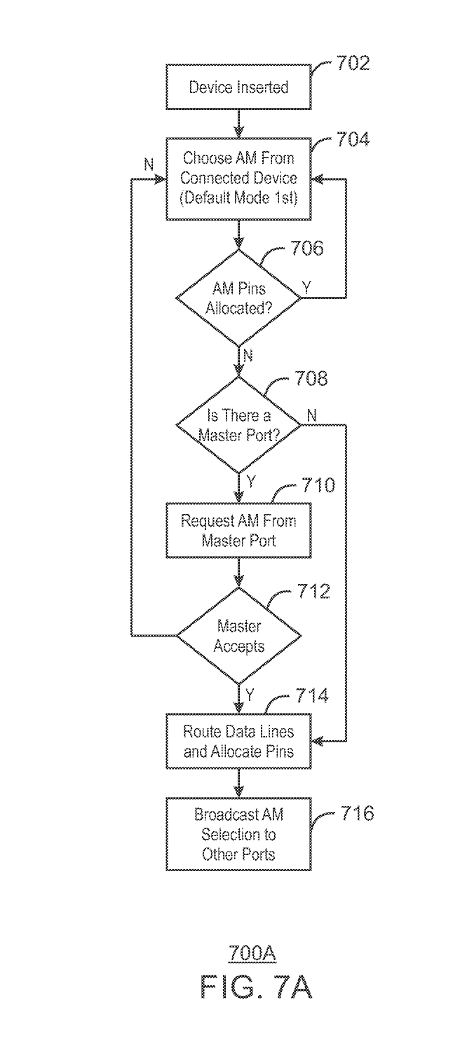

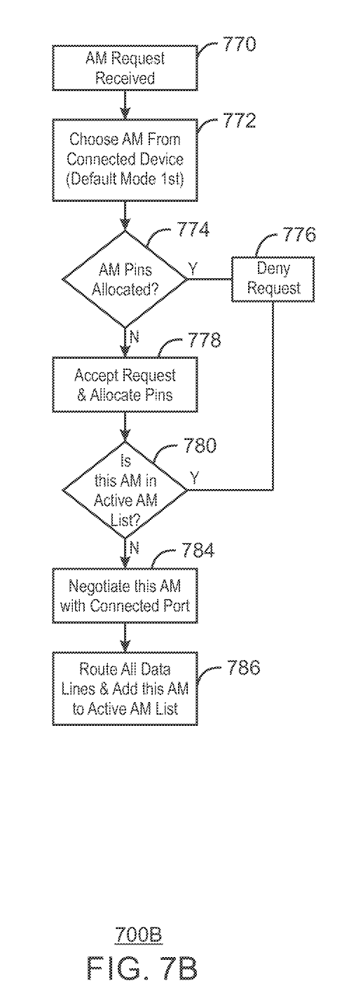

FIG. 7A is a process flow diagram of a method 700A for a slave port chip edge policy manager. At block 702, a device is inserted. The device may be inserted at any port of the system, on either the host system or dock. At block 704, an alternate mode is selected from the connected device. The default mode of the port is selected first. At block 706 it is determined if the selected alternate mode pins are allocated. If the selected alternate mode pins are allocated, process flow returns to block 704 to choose another alternate mode. If the selected alternate mode pins are not allocated, process flow continues to block 708.

At block 708, it is determined if there is a master port. If there is a master port, process flow continues to block 710. If there is no master port, process flow continues to block 714. At block 710, the alternate mode is requested form the master port. In this manner, the slave port can “check in” with the master port for the availability of the desired alternate mode. At block 712, it is determined if the master port accepts the alternate mode requested by the slave port. If the master port accepts the alternate mode requested by the slave port, process flow continues to block 714. If the master port does not accept the alternate mode requested by the slave port, process flow returns to block 704 where another alternate mode is selected. At block 714, data lines are routed and pins are allocated according to the selected alternate mode. At block 716, the alternate mode selected at the slave port and approved by the master port is broadcast to other ports.

As shown in FIG. 7A, when a port chip is not a slave (i.e., there is no master port) the port chip will negotiate the alternate mode on its own using the Allocated Pin register to determine what alternate mode can be accepted. If the port chip is a slave, it asks the master for permission to use an alternate mode. If the master accepts the alternate mode, the slave configures the data lines and saves its Allocated Pin state. However, if the alternate mode is rejected the slave selects another of the endpoint alternate modes and again requests permission from the master to use the alternate mode. The master accepts the alternate mode, the slave sends a message to the other port chips that it shares resources with information on the connection that has been accepted. Each port chip will react according to its position in the chain. For example, a slave walk-up port will simply update its Allocated Pin register, while the master dock port may ignore this broadcast message as it would have already updated its state and possibly the connection alternate mode when the master accepted the alternate mode request.

FIG. 7B is a process flow diagram a method 700B for a master port chip edge policy manager. At block 770, the alternate mode request if received. At block 772, an alternate mode is selected from the connected device. The default mode of the port is selected first. At block 774, it is determined if the selected alternate mode pins are allocated. If the selected alternate mode pins are allocated, process flow continues to block 776 where the alternate mode request is denied. If the selected alternate mode pins are not allocated, process flow continues to block 778.

At block 778, the request for an alternate mode from the slave port is accepted and the pins for that particular alternate mode are allocated to the slave. At block 780, it is determined if the alternate mode is active in the alternate mode list. If the alternate mode is active in the alternate mode list, process flow continues to block 776 where the alternate mode request is denied. At block 784, the alternate mode is negotiated with the connected port. At block 786, all data lines are routed and the alternate mode is added to the active alternate mode list.

The advantages of EPM are that the same code is running on each port chip, the only difference being the supported alternate modes and multiplexer settings for data routing which is a small amount of data. In embodiments, the same firmware stock keeping unit (SKU) is on every port chip with a downloadable configuration. The SKU is used to denote a unique instance of a product, and each copy manufactured of a specific SKU is identical. In this context, the firmware code image is identical for all port chips. It is personalized using downloadable configuration data. Additionally, Type-C alternate mode negotiations in EPM can be faster when compared to centralized policy management, because unlike a central policy manager decisions do not have to be linearized thru the central policy management code. Even when communicating with the master port chip, the request can be processed with a simple bitmask comparison of a register.

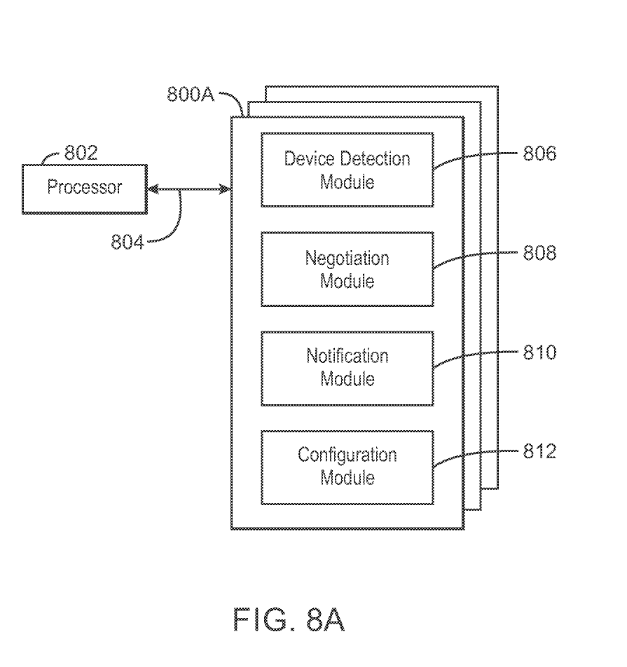

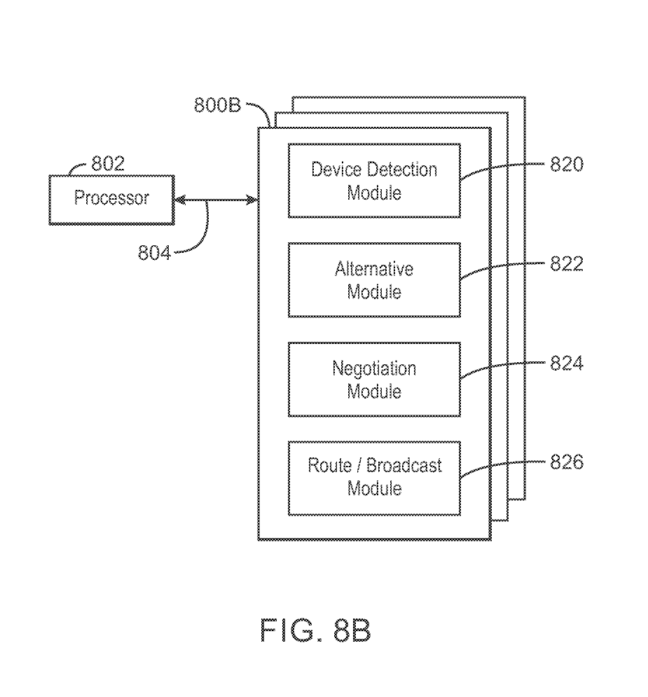

FIG. 8A is a block diagram showing tangible, non-transitory computer-readable media 800A that stores code for a centralized policy manager. The tangible, non-transitory computer-readable media 800A may be accessed by a processor 802 over a computer bus 804. Furthermore, the tangible, non-transitory computer-readable medium 800A may include code configured to direct the processor 802 to perform the methods described herein.

The various software components discussed herein may be stored on one or more tangible, non-transitory computer-readable media 800A, as indicated in FIG. 8A. For example, a detection module 806 may be configured to detect the connection of a device to system. The device can be connected at a host system or a dock. A negotiation module 808 may be configured to negotiate the quality of the connection. In embodiments, a DisplayPort device may be the first device connected to the system, and the resolution is negotiated based on the other devices connected to the system as well as the capabilities of the DisplayPort device. Further, in embodiments a USB device may be the first device connected to the system, and the USB speed is negotiated based on the other devices connected to the system as well as the capabilities of the USB device. At block 810, a notification module is notify the host or system or the status of the possible connections. For example, when the DisplayPort device is connected to a port the dock may be notified via HID messaging that 4K resolution is denied. The host may also be notified that HD negotiation is complete. Similarly, when the USB device is connected to a port the dock may be notified that USB3 is denied. The host may also be notified that USB3 or USB2 negotiation is complete. At block 812, the configuration module is to configure the dock or host according to the currently alternate modes selected.

The block diagram of FIG. 8A is not intended to indicate that the tangible, non-transitory computer-readable media 800A is to include all of the components shown in FIG. 8A. Further, the tangible, non-transitory computer-readable media 800A may include any number of additional components not shown in FIG. 8A, depending on the details of the specific implementation.

FIG. 8B is a block diagram showing tangible, non-transitory computer-readable media 800B that stores code for an edge policy manager. The tangible, non-transitory computer-readable media 800A may be accessed by a processor 802 over a computer bus 804. Furthermore, the tangible, non-transitory computer-readable medium 800 may include code configured to direct the processor 802 to perform the methods described herein.

The various software components discussed herein may be stored on one or more tangible, non-transitory computer-readable media 800, as indicated in FIG. 8. For example, a device detection module 820 may be configured to detect the connection of a device to system and the default alternate mode of the device. An alternative detection module 822 may be configured to determine if the selected alternate mode pins are allocated. At block 824, a negotiation module is to determine if the master port accepts the alternate mode, or if a port chip is to negotiate the selected alternate mode. At block 826, a route/broadcast module is to route the data lines, allocate pins, and broadcast the alternate mode selection to other ports.

The block diagram of FIG. 8B is not intended to indicate that the tangible, non-transitory computer-readable media 800B is to include all of the components shown in FIG. 8B. Further, the tangible, non-transitory computer-readable media 800B may include any number of additional components not shown in FIG. 8B, depending on the details of the specific implementation.

Note that the apparatus', methods', and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

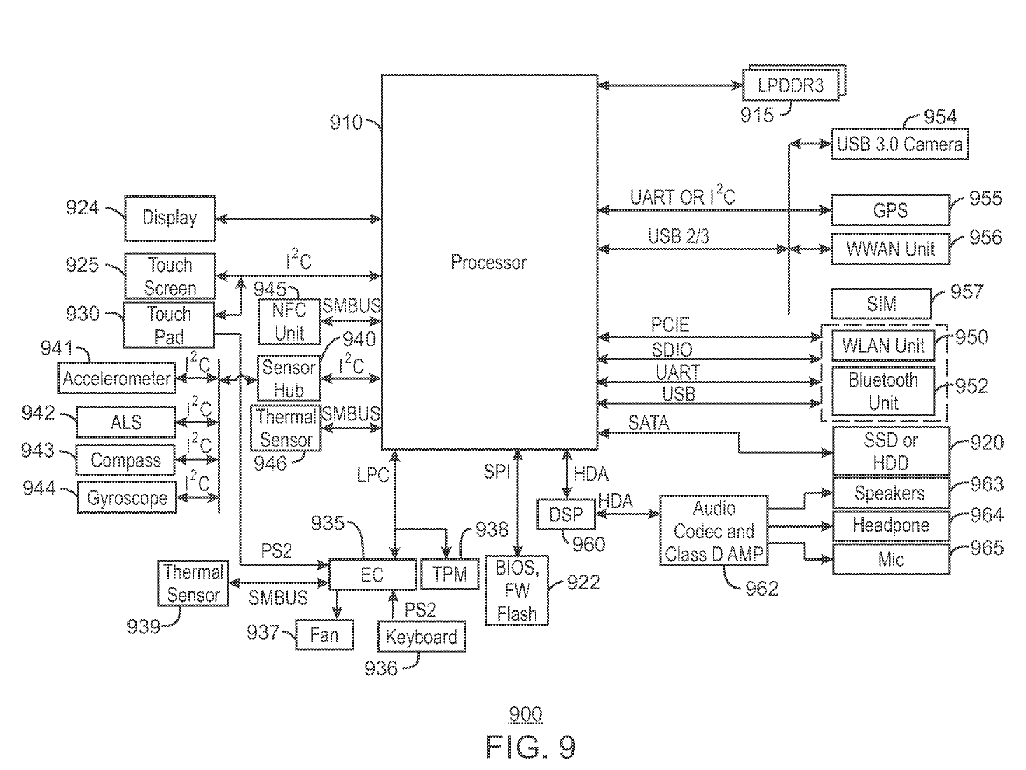

Referring now to FIG. 9, a block diagram of components present in a computer system in accordance with an embodiment of the present invention is illustrated. As shown in FIG. 9, system 900 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 9 is intended to show a high level view of many components of the computer system. However, it is to be understood that some of the components shown may be omitted, additional components may be present, and different arrangement of the components shown may occur in other implementations. As a result, the invention described above may be implemented in any portion of one or more of the interconnects illustrated or described below.

As seen in FIG. 9, a processor 910, in one embodiment, includes a microprocessor, multi-core processor, multithreaded processor, an ultra low voltage processor, an embedded processor, or other known processing element. In the illustrated implementation, processor 910 acts as a main processing unit and central hub for communication with many of the various components of the system 900. As one example, processor 900 is implemented as a system on a chip (SoC). As a specific illustrative example, processor 910 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitectural implementation may vary, but the architectural function of the processor is usually consistent. Certain details regarding the architecture and operation of processor 910 in one implementation will be discussed further below to provide an illustrative example.

Processor 910, in one embodiment, communicates with a system memory 915. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (Q17P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 920 may also couple to processor 910. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 9, a flash device 922 may be coupled to processor 910, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in an mSATA or NGFF slot. As an example, an SSD has a capacity ranging from 120 GB-1 TB.

Various input/output (IO) devices may be present within system 900. Specifically shown in the embodiment of FIG. 9 is a display 924 which may be a high definition LCD or LED panel configured within a lid portion of the chassis. This display panel may also provide for a touch screen 925, e.g., adapted externally over the display panel such that via a user's interaction with this touch screen, user inputs can be provided to the system to enable desired operations, e.g., with regard to the display of information, accessing of information and so forth. In one embodiment, display 924 may be coupled to processor 910 via a display interconnect that can be implemented as a high performance graphics interconnect. Touch screen 925 may be coupled to processor 910 via another interconnect, which in an embodiment can be an I²C interconnect. As further shown in FIG. 9, in addition to touch screen 925, user input by way of touch can also occur via a touch pad 930 which may be configured within the chassis and may also be coupled to the same I²C interconnect as touch screen 925.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Alternatively, the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 4:3 or 16:9 aspect ratio, and at least 300 nits brightness. Also the display may be of full high definition (HD) resolution (at least 1920×1080p), be compatible with an embedded display port (eDP), and be a low power panel with panel self-refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited IO interference when using multi-touch.

For perceptual computing and other purposes, various sensors may be present within the system and may be coupled to processor 910 in different manners. Certain inertial and environmental sensors may couple to processor 910 through a sensor hub 940, e.g., via an I²C interconnect. In the embodiment shown in FIG. 9, these sensors may include an accelerometer 941, an ambient light sensor (ALS) 942, a compass 943 and a gyroscope 944. Other environmental sensors may include one or more thermal sensors 946 which in some embodiments couple to processor 910 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

In an embodiment, the OS may be a Microsoft® Windows® 8 OS that implements Connected Standby (also referred to herein as Win8 CS). Windows 8 Connected Standby or another OS having a similar state can provide, via a platform as described herein, very low ultra idle power to enable applications to remain connected, e.g., to a cloud-based location, at very low power consumption. The platform can supports 3 power states, namely screen on (normal); Connected Standby (as a default “off” state); and shutdown (zero watts of power consumption). Thus in the Connected Standby state, the platform is logically on (at minimal power levels) even though the screen is off. In such a platform, power management can be made to be transparent to applications and maintain constant connectivity, in part due to offload technology to enable the lowest powered component to perform an operation.

Also seen in FIG. 9, various peripheral devices may couple to processor 910 via a low pin count (LPC) interconnect. In the embodiment shown, various components can be coupled through an embedded controller 935. Such components can include a keyboard 936 (e.g., coupled via a PS2 interface), a fan 937, and a thermal sensor 939. In some embodiments, touch pad 930 may also couple to EC 935 via a PS2 interface. In addition, a security processor such as a trusted platform module (TPM) 938 in accordance with the Trusted Computing Group (TCG) TPM Specification Version 1.2, dated Oct. 2, 2003, may also couple to processor 910 via this LPC interconnect. However, understand the scope of the present invention is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus Revision 3.1 Specification (August 2014), with at least one powered for charging of USB devices (such as smartphones) when the system is in Connected Standby state and is plugged into AC wall power. In addition, one or more Thunderbolt™ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick. In some embodiments, USB Type-C ports may be used for one or more of the following signal types separately or in combination: USB2, USB3, Analog Audio, Digital Audio, power delivery, Display Port, HDMI, PCI-Express, and others; including numerous vendor-proprietary signaling schemes.

System 900 can communicate with external devices in a variety of manners, including wirelessly. In the embodiment shown in FIG. 9, various wireless modules, each of which can correspond to a radio configured for a particular wireless communication protocol, are present. One manner for wireless communication in a short range such as a near field may be via a near field communication (NFC) unit 945 which may communicate, in one embodiment with processor 910 via an SMBus. Note that via this NFC unit 945, devices in close proximity to each other can communicate. For example, a user can enable system 900 to communicate with another (e.g.,) portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 9, additional wireless units can include other short range wireless engines including a WLAN unit 950 and a Bluetooth unit 952. Using WLAN unit 950, Wi-Fi™ communications in accordance with a given Institute of Electrical and Electronics Engineers (IEEE) 802.11 standard can be realized, while via Bluetooth unit 952, short range communications via a Bluetooth protocol can occur. These units may communicate with processor 910 via, e.g., a USB link or a universal asynchronous receiver transmitter (UART) link. Or these units may couple to processor 910 via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 956 which in turn may couple to a subscriber identity module (SIM) 957. In addition, to enable receipt and use of location information, a GPS module 955 may also be present. Note that in the embodiment shown in FIG. 9, WWAN unit 956 and an integrated capture device such as a camera module 954 may communicate via a given USB protocol such as a USB 2.0 or 3.0 link, or a UART or I²C protocol. Again the actual physical connection of these units can be via adaptation of a NGFF add-in card to an NGFF connector configured on the motherboard.

In a particular embodiment, wireless functionality can be provided modularly, e.g., with a WiFi™ 802.11 ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 960, which may couple to processor 910 via a high definition audio (HDA) link. Similarly, DSP 960 may communicate with an integrated coder/decoder (CODEC) and amplifier 962 that in turn may couple to output speakers 963 which may be implemented within the chassis. Similarly, amplifier and CODEC 962 can be coupled to receive audio inputs from a microphone 965 which in an embodiment can be implemented via dual array microphones (such as a digital microphone array) to provide for high quality audio inputs to enable voice-activated control of various operations within the system. Note also that audio outputs can be provided from amplifier/CODEC 962 to a headphone jack 964. Although shown with these particular components in the embodiment of FIG. 9, understand the scope of the present invention is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 910 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the I/O pins for several I/O signals, such as the interface between the processor and a PCH, the interface with the external VR and the interface with EC 935. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC 935 may be sent to the PCH instead of the processor during the connected standby state so that the PCH can manage the wakeup processing instead of the processor. In addition, the TSC is maintained in the PCH to facilitate sustaining processor architectural functions. Although shown with these particular components in the embodiment of FIG. 9, understand the scope of the present invention is not limited in this regard.

Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

Some implementations may provide a specific power management IC (PMIC) to control platform power. Using this solution, a system may see very low (e.g., less than 5%) battery degradation over an extended duration (e.g., 16 hours) when in a given standby state, such as when in a Win8 Connected Standby state. In a Win8 idle state a battery life exceeding, e.g., 9 hours may be realized (e.g., at 150 nits). As to video playback, a long battery life can be realized, e.g., full HD video playback can occur for a minimum of 6 hours. A platform in one implementation may have an energy capacity of, e.g., 35 watt hours (Whr) for a Win8 CS using an SSD and (e.g.,) 40-44 Whr for Win8 CS using an HDD with a RST cache configuration.

A particular implementation may provide support for 15 W nominal CPU thermal design power (TDP), with a configurable CPU TDP of up to approximately 25 W TDP design point. The platform may include minimal vents owing to the thermal features described above. In addition, the platform is pillow-friendly (in that no hot air is blowing at the user). Different maximum temperature points can be realized depending on the chassis material. In one implementation of a plastic chassis (at least having to lid or base portion of plastic), the maximum operating temperature can be 52 degrees Celsius (C). And for an implementation of a metal chassis, the maximum operating temperature can be 46° C.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

### Example 1

An apparatus for configuring connection modes is described herein. The apparatus includes a plurality of ports and a processor. A first port is to couple a first device to the apparatus, the first port configurable to communicate via one mode of a plurality of modes. The processor is to include a policy manager, wherein the policy manager is to negotiate the one mode at the first port based on a mode of a second port of the plurality of ports.

In some embodiments, the policy manager is a centralized policy manager. The policy manager may also be an edge policy manager. The negotiated alternate mode may be saved in a database. The saved alternate mode may be obtained for the first port. The plurality of ports may include a dock port, a dock receptacle, and a walk-up port.

In embodiments, the mode may be a display port mode; the mode may be a USB mode; the mode may be a PCI-E mode. The plurality of ports may be configured in a master/slave relationship, wherein a third port may be a master port. The master port may be a dock plug port. The port chips associated with the plurality of ports may communicate via an I2C communication channel. Additionally, communication channel (CC) lines may be used to broadcast modes.

### Example 2

A system for configuring connection modes is described herein. The system includes a microcontroller, a plurality of port chips, and at least one policy manager. The microcontroller is to communicate with the plurality of port chips and the plurality of port chips share at least one connection. The policy manager is to negotiate an alternate mode of each port chip in response to an endpoint coupled with a port corresponding to a port chip of the plurality of port chips.

In embodiments, the microcontroller may be included in a dock, and the dock may be to couple with a tablet, the tablet including a subset of the plurality of port chips. The policy manager may also be distributed among each of the plurality of port chips. Further, the policy manager may be located on the microcontroller. The port chips may communicate via a communication channel. The negotiated mode can be saved in a database. The saved mode can be obtained for a device in response to the device being coupled with the port corresponding to the port chip. The shared connection may be a USB Type-C connection. The policy manger may negotiate for a highest quality connection whenever a Type-C device may be coupled with a port associated with a port chip. The mode can be a display port mode; the mode can be a USB mode; and the mode can be a PCI-E mode. The plurality of ports can be configured in a master/slave relationship.

### Example 3

A method for configuring connection modes is described herein. The method includes detecting a connection of a device and negotiating the quality of the connection based on modes of the device. The method also includes selecting a mode and configuring a host or dock based on the selected mode.

In embodiments, negotiating the quality of the connection may be enabled by a policy manager that distributes resources among a plurality of ports. The policy manager may be an edge policy manager, or the policy manager may be a centralized policy manager. A policy manager can negotiate the quality of the connection based on the plurality of modes of the device. The connection may be a USB Type-C connection. A first mode may be DisplayPort 4k and a second mode may be USB2. Additionally, a first mode may be DisplayPort HD and a second mode may be USB3. Further, a first mode may be PCI-Express and a second mode may be USB2. The selected mode may be broadcast via advisory information messages. The advisory information messages may be exchanged via a communication channel using unstructured or structured vendor defined messaging (VDM). The advisory information messages may also be exchanged as a Human Interface Device (HID) message.

### Example 4

An apparatus for configuring connection modes is described herein. The apparatus includes a plurality of ports and a means to manage a connection. A first endpoint may be to couple with a first port of the plurality of ports and may be to implement a mode. The means to manage the connection may be to negotiate the mode at the first port based on a mode of a second endpoint to couple with a second port of the plurality of ports.

In embodiments, the means to manage the connection may be a centralized policy manager. The means to manage the connection may also be an edge policy manager. The negotiated mode may be saved in a database. The saved mode for the first endpoint may be obtained from the database. The plurality of ports includes a dock port, a dock receptacle, and a walk-up port. The mode may be a display port mode; the mode may be a USB mode; and the mode may be a PCI-E mode. The plurality of ports may be configured in a master/slave relationship, wherein a third port may be a master port. The master port may be a dock plug port. The port chips associated with the plurality of ports may to communicate via an I2C communication channel. Communication channel (CC) lines may be used to broadcast modes.

### Example 5

At least one computer readable medium for configuring connection modes is described herein, the computer readable medium having instructions stored therein that, in response to being executed on a computing device, cause the computing device to detect a connection of a device and negotiate the quality of the connection based on modes of the device. The computer readable medium also has instructions stored therein that, in response to being executed on a computing device, cause the computing device to select a mode and configure a host or dock based on the selected mode.

In embodiments, negotiating the quality of the connection may be enabled by a policy manager that distributes resources among a plurality of ports. The policy manager may be an edge policy manager, or the policy manager may be a centralized policy manager. The policy manager may negotiate the quality of the connection based on modes of the device. The connection may be a USB Type-C connection. A first mode may be DisplayPort 4k and a second mode may be USB2. Additionally, a first mode may be DisplayPort HD and a second mode may be USB3. Further, a first mode may be PCI-Express and a second mode may be USB2. The selected mode may be broadcast via advisory information messages. The advisory information messages may be exchanged via a communication channel using unstructured or structured vendor defined messaging (VDM). The advisory information messages may also be exchanged as a Human Interface Device (HID) message.

While the present techniques have been described with respect to a limited number of embodiments, those skilled in the art will appreciate numerous modifications and variations therefrom. It is intended that the appended claims cover all such modifications and variations as fall within the true spirit and scope of this present techniques.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present techniques.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the present techniques may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present techniques. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the present techniques as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus for configuring connection modes, comprising:
a plurality of ports, including a first port to couple a first device to the apparatus, the first port configurable to communicate via one mode of a plurality of modes;
a processor including a policy manager, wherein the policy manager is to negotiate the one mode at the first port based on a mode of a second port of the plurality of ports.

2. The apparatus of claim 1, wherein the policy manager is a centralized policy manager.

3. The apparatus of claim 1, wherein the policy manager is an edge policy manager.

4. The apparatus of claim 1, wherein the negotiated mode is saved in a database.

5. The apparatus of claim 1, comprising obtaining the saved mode for the first port.

6. The apparatus of claim 1, wherein the plurality of ports includes a dock port, a dock receptacle, and a walk-up port.

7. The apparatus of claim 1, wherein the mode is a display port mode.

8. The apparatus of claim 1, wherein the mode is a USB mode.

9. The apparatus of claim 1, wherein the mode is a PCI-E mode.

10. The apparatus of claim 1, wherein the plurality of ports are configured in a master/slave relationship, wherein a third port is a master port.

11. A system for configuring connection modes, comprising:
a microcontroller;
a plurality of port chips, wherein the microcontroller is to communicate with the plurality of port chips and the plurality of port chips share at least one connection; and
at least one policy manager, wherein the policy manager is to negotiate a mode of each port chip in response to a device coupled with a port corresponding to a port chip of the plurality of port chips.

12. The system of claim 11, wherein the microcontroller is included in a dock, and the dock is to couple with a tablet, the tablet including a subset of the plurality of port chips.

13. The system of claim 11, wherein the policy manager is distributed among each of the plurality of port chips.

14. The system of claim 11, wherein the policy manager is located on the microcontroller.

15. The system of claim 11, wherein the policy manager is located on the microcontroller, and the port chips communicate via a communication channel.

16. The system of claim 11, wherein the negotiated mode is saved in a database.

17. The system of claim 11, comprising saving the negotiated mode in a database and obtaining the saved mode for the device from the database in response to the endpoint being coupled with the port corresponding to the port chip.

18. The system of claim 11, wherein the shared connection is a USB Type-C connection.

19. The system of claim 11, wherein the policy manger is to negotiate for a highest quality connection whenever a Type-C device is coupled with a port associated with a port chip.

20. A method for configuring connection modes, comprising:
detecting a connection of a device;
negotiating the quality of the connection based on a plurality of modes of the device;
selecting a mode; and
configuring a host or dock based on the selected mode.

21. The method of claim 20, wherein negotiating the quality of the connection is enabled by a policy manager that distributes resources among a plurality of ports.

22. The method of claim 20, comprising a policy manager, wherein the policy manager is an edge policy manager.

23. The method of claim 20, comprising a policy manager, wherein the policy manager is a centralized policy manager.

24. The method of claim 20, wherein a policy manager negotiates the quality of the connection based on the modes of the device.

25. The method of claim 20, wherein the connection is a USB Type-C connection.
